(19) United States
(12) Patent Application Publication
(10) Pub. No.: US 2017/0168957 A1
(43) Pub. Date: Jun. 15, 2017

(54) Aware Cache Replacement Policy

(71) Applicant: ATI Technologies ULC, Markham (CA)

(72) Inventor: Kostantinos D. Christidis, Markham (CA)

(21) Appl. No.: 14/965,132

(22) Filed: Dec. 10, 2015

(51) Int. Cl. G06F 12/12; G06F 12/08

(52) U.S. Cl. CPC G06F 12/124; G06F 12/122; G06F 12/0804; G06F 2212/1021; G06F 2212/281; G06F 2212/69

(57) ABSTRACT

An aware cache replacement policy increases the length of in-page bursts of cache eviction memory requests and promotes bank-rotation to reduce the likelihood of memory bank-conflicts as compared to other cache replacement policies. The aware cache replacement policy increases the amount of valid data on the memory bus and reduces the impact of main memory precharge and activate times by evicting cache blocks in bursts based on temporal and spatial locality according to requesting thread and/or memory structure.

### BACKGROUND

Field of the Invention

The invention is related to memory systems and more particularly to cache replacement policies in memory systems.

Description of the Related Art

In a typical computing system, a memory system is designed with a goal of low latency experienced by a processor when accessing arbitrary units of data. In general, the memory system design leverages properties of data elements known as temporal locality and spatial locality. Temporal locality refers to multiple accesses of specific memory locations within a relatively small time period. Spatial locality refers to accesses of relatively close memory locations within a relatively small time period.

Typically, temporal locality is evaluated in terms of a granularity smaller than that of a next level in a memory hierarchy. For example, a cache captures a repeated access of blocks (e.g., 64 Bytes (B)), which is smaller than the storage granularity of main memory (e.g., 4 Kilobyte (KB) pages). Spatial locality is typically captured by storing quantities of data slightly larger than a requested quantity in order to reduce memory access latency in the event of sequential access. For example, a cache is designed to store 64B blocks, although a processor requests one to eight Bytes at a time. Meanwhile, the cache requests 64B at a time from a memory, which stores pages of 4 KB contiguous portions.

In general, typical memory system designs capture whatever temporal and spatial locality information that can be culled from the memory streams they are servicing in a strictly ordered and independent manner. For example, a level-two (L2) cache of a memory system having three cache levels only receives memory accesses missed in a level-one (L1) cache. A level-three (L3) cache only receives memory accesses that have already been filtered through both of the L1 and the L2 caches. Similarly, a main memory (e.g., dynamic random access memory (DRAM)) only receives memory accesses that have been filtered through the entire cache hierarchy. Accordingly, each level of the memory hierarchy has visibility to only the temporal and spatial locality of memory accesses that have been passed from the previous level(s) of the hierarchy (e.g., cache misses) and only at the granularity of that particular level. Of particular interest is the filtering of memory accesses by a last-level cache (i.e., a cache level that is closest to the main memory), typically an L3 cache, to memory. In a typical memory system, the last-level cache and main memory form a shared memory portion (i.e., a memory portion shared by all executing threads) and capture global access patterns.

A conventional last-level cache is a write-back cache in which information is written only to the cache block in the cache. The modified cache block is written to main memory only when it is replaced. In response to a write hit, a thread requesting the memory access writes the addressable unit into the cache and sets a corresponding dirty bit, if not already set, to indicate modification of the addressable unit. At a future time, e.g., when the cache block must be evicted from the cache for a cache miss, only the dirty block(s) are written back to the main memory. When a full sector is moved to main memory (e.g., cache flush) dirty bits are not used. Using dirty bit control, only the last write to a cache block is written to the main memory, which reduces bus activity as compared to other cache policies. A read miss or a write miss may require a write back to memory if the evicted cache block is dirty. Thus, the selection of a replacement policy can impact the transport time required to service a read or a write miss. Cache write-backs can consume large portions of memory bandwidth. Accordingly, improved cache replacement techniques are desired.

### SUMMARY OF EMBODIMENTS OF THE INVENTION

In at least one embodiment of the invention, a method includes concurrently executing a plurality of threads. The method includes, in response to a first memory request issued by a first thread of the plurality of threads resulting in a cache miss of a write-back cache memory, selecting a cache block of the write-back cache for eviction. The cache block is selected using thread temporal information corresponding to cache block usage by each thread executing on the at least one processor and global temporal information for cache block usage for all threads of the plurality of threads. The method may include updating the thread temporal information and the global temporal information in response to the first memory request. The method may include generating a write-back burst including a write request for each dirty cache block and write requests for additional dirty cache blocks of the write-back cache for eviction. The burst of memory requests may have addresses in a common portion of memory. The method may include selecting the additional cache blocks of the write-back cache for eviction based on a predetermined number of memory requests for a write-back burst. Generating the write-back burst may include selecting a plurality of additional cache blocks of the write-back cache for eviction targeting the common portion of memory of the cache block. The selecting may include determining that the cache block is not a most-recently-used cache block for a global cache block temporal usage policy.

In at least one embodiment of the invention, an apparatus includes at least one processor configured to concurrently execute a plurality of threads and a write-back cache. The write back cache includes a global temporal information storage element configured to store temporal information for cache block usage by all threads of the plurality of threads. The write back cache includes a thread temporal information storage element configured to store temporal information for cache block usage by each thread of the plurality of threads. The write back cache includes a replacement and write-back controller configured to select a cache block of the write-back cache for eviction in response to a first memory request issued by a first thread of the plurality of threads resulting in a cache miss of the write-back cache. The replacement and write-back controller is configured to select the cache block using contents of the global temporal information storage element and contents of the thread temporal information storage element. The write-back cache may further include a write-back memory request queue configured to store write requests corresponding to dirty cache blocks selected for eviction from the write-back cache. The apparatus may include a memory controller configured to write to main memory, data of the write requests in the write-back memory request queue. The write-back cache may further include a bank temporal information storage element configured to store temporal information for each bank of main memory. The write-back cache memory may include a burst size storage element configured to store a number corresponding to a predetermined number of memory requests in a write-back burst. The replacement and write-back controller may be configured to select a plurality of additional cache blocks of the write-back cache for eviction based on contents of the burst size storage element. The replacement and write-back controller may be further configured to write the write request to the write-back memory request queue in absence of a conflict with a global cache block temporal usage policy.

In at least one embodiment of the invention, a method for reducing memory access time of a cache flush includes, in response to receiving a cache flush trigger, generating a write-back memory request stream to a main memory. The write-back memory request stream includes a write request corresponding to each valid and dirty cache block. The write memory request stream includes bursts of write requests. Each write request in each burst has a destination location in a first portion of the main memory. The first portion may be a first memory bank. The first portion may be a first row of a first memory bank.

### BRIEF DESCRIPTION OF THE DRAWINGS

The present invention may be better understood, and its numerous features and advantages made apparent to those skilled in the art by referencing the accompanying drawings.

FIG. 1 illustrates a functional block diagram of a processing system including a write-back cache with an aware cache replacement policy consistent with at least one embodiment of the invention.

FIG. 2 illustrates a functional block diagram of an exemplary main memory of the processing system of FIG. 1.

FIG. 3 illustrates a functional block diagram of write-back cache with an aware cache replacement policy of the processing system of FIG. 1 consistent with at least one embodiment of the invention.

FIG. 4 illustrates a functional block diagram of an aware replacement and write-back unit of the write-back cache of FIG. 3 consistent with at least one embodiment of the invention.

FIG. 5 illustrates a functional block diagram of an aware replacement and write-back unit of the write-back cache of FIG. 3 consistent with at least one embodiment of the invention.

FIG. 6 illustrates information and control flows for the write-back cache with an aware cache replacement policy of the processing system of FIG. 3 consistent with at least one embodiment of the invention.

FIG. 7 illustrates information and control flows for the write-back cache with an aware cache replacement policy of the processing system of FIG. 3 consistent with at least one embodiment of the invention.

FIG. 8 illustrates information and control flows for a conflict resolution policy of the write-back cache with an aware cache replacement policy of FIG. 3 consistent with at least one embodiment of the invention.

FIG. 9 illustrates information and control flows for a cache flush of the write-back cache with an aware cache replacement policy of FIG. 3 consistent with at least one embodiment of the invention.

The use of the same reference symbols in different drawings indicates similar or identical items.

### DETAILED DESCRIPTION

An aware cache replacement policy increases the length of in-page bursts of cache eviction memory requests and promotes bank-rotation to reduce the likelihood of memory bank-conflicts as compared to other cache replacement policies. The aware cache replacement policy increases the amount of valid data on the memory bus and reduces the impact of main memory pre-charge and activate times by evicting cache blocks in bursts based on temporal and spatial locality according to requesting thread and/or memory structure.

A typical write-back cache uses a global least-recently-used replacement policy. The cache may evict cache blocks and generate a memory request stream that interleaves memory accesses for multiple threads executing on the system, each thread accessing different portions (e.g., rows) of memory. For example, a global least-recently-used replacement policy generates a memory request stream to a particular memory bank including memory request 0 for thread A to row 0 of memory, memory request 1 for thread B to row 1 of memory, memory request 2 for thread C to row 2 of memory, and memory request 3 for thread D to row 3 of memory. Such sequences to the same bank cause page conflicts and increase memory latency. An aware cache replacement policy may increase the efficiency of the memory request stream by evicting multiple cache blocks associated with a particular thread before evicting cache blocks associated with other threads.

The aware cache replacement policy may improve efficiency by generating a burst of memory requests to the same portion of memory. However, if individual threads are memory access inefficient, the burst of memory requests may not substantially improve memory latency. For example, multiple memory requests to the same bank including memory request 0 for thread A to row 0 of memory, memory request 1 for thread A to row 1 of memory, memory request 2 for thread A to row 2 of memory, and memory request 3 for thread A to row 3 of memory may be impacted by latency penalties due to sequential accesses to different rows of the same memory bank.

In addition to evicting cache blocks in bursts based on the requesting thread, the aware cache replacement policy considers memory structure to generate an in-page burst where the cache evicts a target number of cache blocks to the same row as the row of the least-recently-used cache block for a same or different thread. Such policy may result in the following sequence: memory request 0 for thread A to row 0 of memory, memory request 1 for thread A to row 0 of memory, memory request 2 for thread A to row 0 of memory, memory request 3 for thread A to row 0 of memory. A similar sequence of memory requests includes four memory requests to the same row of memory but associated with multiple different threads: memory request 0 for thread A to row 0 of memory, memory request 1 for thread A to row 0 of memory, memory request 2 for thread A to row 0 of memory, memory request 3 for thread B to row 0 of memory. The least-recently-used cache block for a thread identifies a first cache block for eviction of a burst of cache blocks for eviction. The cache continues to select cache blocks for eviction until a target number of cache blocks are evicted (e.g., resulting in a target number of page hits by the write-back memory accesses) before looking at temporal information again.

High memory bandwidth efficiency may be achieved by rotating through memory banks with enough requests to hide the pre-charge and activate times of each bank with the goal of keeping valid data on the memory bus at all times. Cache hit rates may benefit from replacement policies that exploit the temporal locality of memory references in a particular workload. For example, a write-back cache may implement a replacement strategy using temporal locality of memory requests in a workload to increase the efficiency of memory requests to main memory for writing back to main memory evicted cache entries. Bank rotation may be used in conjunction with the burst of write-back requests generated by eviction of cache blocks selected based on a thread and memory structure aware cache replacement policy. The cache maintains temporal use information for each memory bank and selects cache blocks for eviction by rotating through the memory banks. After selecting a particular bank, the aware cache replacement policy may select bursts of cache blocks for eviction according to the thread and memory location and then across various threads according to memory location.

In response to a cache flush indicator received from a processor of the system, a typical cache controller evicts cache blocks in index order, resulting in an inefficient stream of memory writes: cache block 0 for thread A to row 0 of memory, cache block 1 for thread B to row 1 of memory, cache block 2 for thread C to row 2 of memory, cache block 3 for thread D to row 3 of memory. Instead of evicting cache blocks in index order, which may result in arbitrary memory access order, the cache control may evict cache blocks in an arbitrary cache index order but to memory locations having spatial locality: memory request 0 to row 0, memory request 1 to row 0, memory request 2 to row 0, memory request 3 to row 1, memory request 4 to row 1, memory request 5 to row 1, memory request 6 to row 2, memory request 7 to row 3 . . . , which results in a stream of memory accesses to the same page of memory, thereby reducing a latency of a cache flush operation.

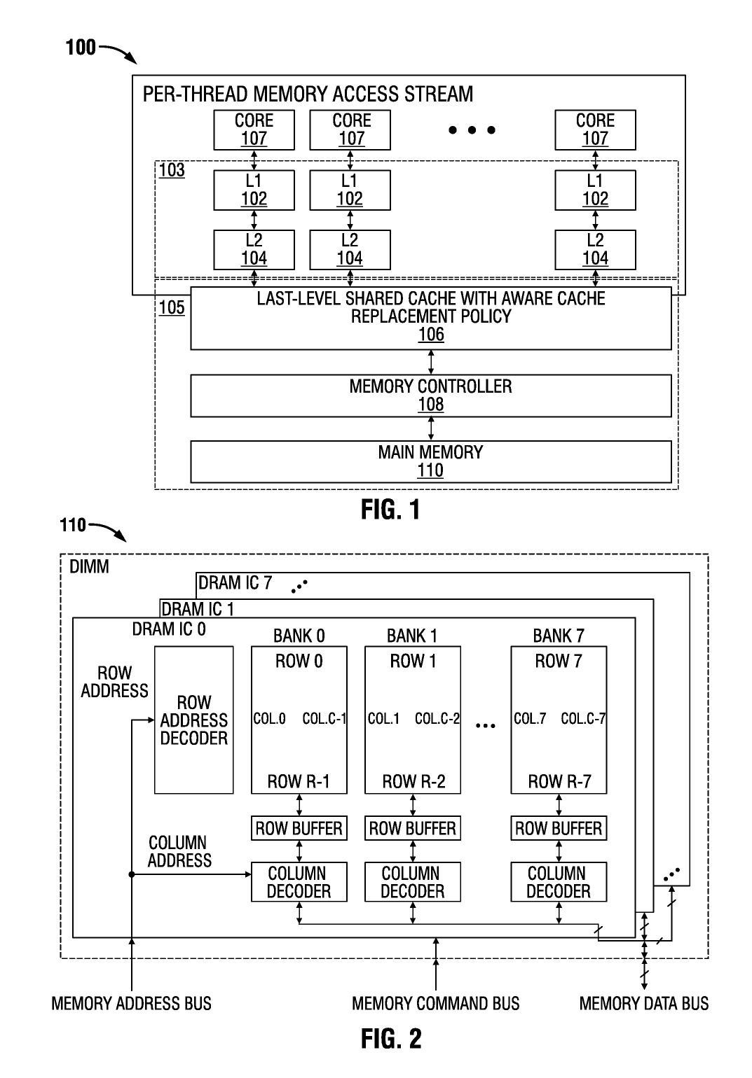

Referring to FIG. 1, in an exemplary processing system (e.g., system 100), multiple threads execute concurrently on one or more cores 107. Cores 107 may be separate processors or processing cores in a multi-core processor, graphics-processing unit, digital signal processing unit or other processor. Cores 107 may fetch and execute multiple instruction streams and operate on multiple data streams. The multiple threads simultaneously execute tasks that may or may not share code and address space. A memory system may include private portions (e.g., memory portion 103) used for storing data for a particular processor (e.g., data for one or more threads executing on a core access only a portion of the personal memory space allocated to the core) and a shared portion (e.g., memory portion 105) of memory that can store data on behalf of multiple cores of system 100. Note that other memory systems may be used. In at least one embodiment, the private and shared portions of the memory system include a multi-level cache (e.g., a multi-level cache including level-one caches (L1) 102, level-two caches (L2) 104, and a shared, last-level cache 106, e.g., a level-three cache (L3), which is the boundary between the per-thread portion of the memory system and the unified access portion of the memory system), memory controller 108, and main memory 110. In at least one embodiment of the memory system, the L1 and L2 caches form memory portion 103, and last-level cache 106, memory controller 108, and main memory 110 form memory portion 105.

In general, information stored in a typical cache is redundant to information stored in main memory 110 and the cache hierarchy is not visible to an operating system executing on one or more of cores 107. Although the entire cache hierarchy may be integrated in an integrated circuit, in at least one embodiment, last-level cache 106 is a stacked memory, i.e., a memory (e.g., dynamic random access memory (DRAM)) that is stacked on top of an integrated circuit including one or more of cores 107 to increase the capacity of the last-level cache from that which may typically be implemented on cores 107. When used as a last-level cache, the contents of the stacked memory are redundant to information stored in main memory 110 and the stacked memory is not visible to an operating system executing on one or more of cores 107. In at least one embodiment, memory controller 108 provides the one or more cores access to a particular portion of memory space (e.g., predetermined portions of main memory 110). Memory controller 108 stores memory requests based on memory requests received from cores 107 in at least one memory request queue. Typical memory architectures rely on memory controller hardware external to the cache to reorder and schedule main memory requests to improve bank-rotation and in-page burst length. External reordering and scheduling hardware requires additional development and increases area of the memory controller. Some memory architectures use increased cache line sizes to promote increased in-page burst lengths at the cost of increased miss rates and miss penalties. A scheduler of memory controller 108 may reorder and schedule memory requests to main memory 110. However, the last-level cache 106 with aware cache replacement policy described herein reduces the amount of reordering required by any scheduler of memory controller 108 and reduces the need to increase cache-line size.

Referring to FIG. 2, main memory 110 includes one or more memory integrated circuits (e.g., one or more DRAM integrated circuits) that are accessed in parallel (e.g., configured as a dual in-line memory module, i.e., DIMM). Each memory integrated circuit includes a data interface (e.g., 8-bit data interface) that is combined with data interfaces of other memory integrated circuits to form a wider data interface (e.g., 64-bit data interface). Each memory integrated circuit includes multiple independent memory banks (e.g., 8 or 16 independent memory banks), which may be accessed in parallel. Each memory bank includes a two-dimensional array of DRAM cells, including multiple rows (e.g., 65,536 rows) and columns (e.g., 1024 columns). Memory controller 108 accesses a location of main memory 110 using a memory address including bank, row, and column fields. However, only one row in a bank may be accessed at a time and the row data is stored in a row buffer dedicated to that bank. An activate command moves a row of data from the memory array into the row buffer. Once the row of data is in the row buffer, a read or write command can read/write data from/to the associated memory address. Thus, the latency of a memory command depends on whether or not a corresponding row is in a row buffer of an associated memory bank.

If the contents of a memory address are already in the row buffer (i.e., the memory address hits the row buffer), then memory controller 108 only needs to issue a read or write command to the memory bank, which has a memory access latency of t_{CL} or t_{WL}, respectively. If the contents of the memory address are not present in the row buffer (i.e., the memory address misses the row buffer), then memory controller 108 needs to precharge the row buffer, issue an activate command to move a row of data into the row buffer, and then issue a read or write command to the memory bank, which, may have an associated memory access latency of t_{RCD}+t_{CL}+t_{RP} or t_{RCD}+t_{WL}+t_{RP}, respectively, for page-conflicts or an associated memory access latency of t_{RCD}+t_{CL} or t_{RCD}+t_{WL}, respectively, for a page-miss where t_{RCD} is the required delay time between an active command row address strobe and a column address strobe and t_{RP} is the row precharge latency.

By increasing the number of cache eviction write-back memory requests that have a memory access latency of t_{WL} rather than t_{RCD}+t_{WL}+t_{RP}, last-level cache 106, which implements an aware cache replacement policy, may reduce the overall memory access latency and may improve system performance as compared to last-level caches with other cache replacement policies. The aware cache replacement policy considers the location of the contents of a cache block in main memory 110 and selects cache blocks for eviction to increase a size of bursts of memory requests to proximate locations in main memory, thereby reducing the memory access latency of main memory 110. In addition, the aware cache replacement policy may reduce the complexity of required scheduling logic in memory controller 108. Note that the main memory architecture of FIG. 2 is exemplary only and the teachings described herein apply to systems including other memory architectures.

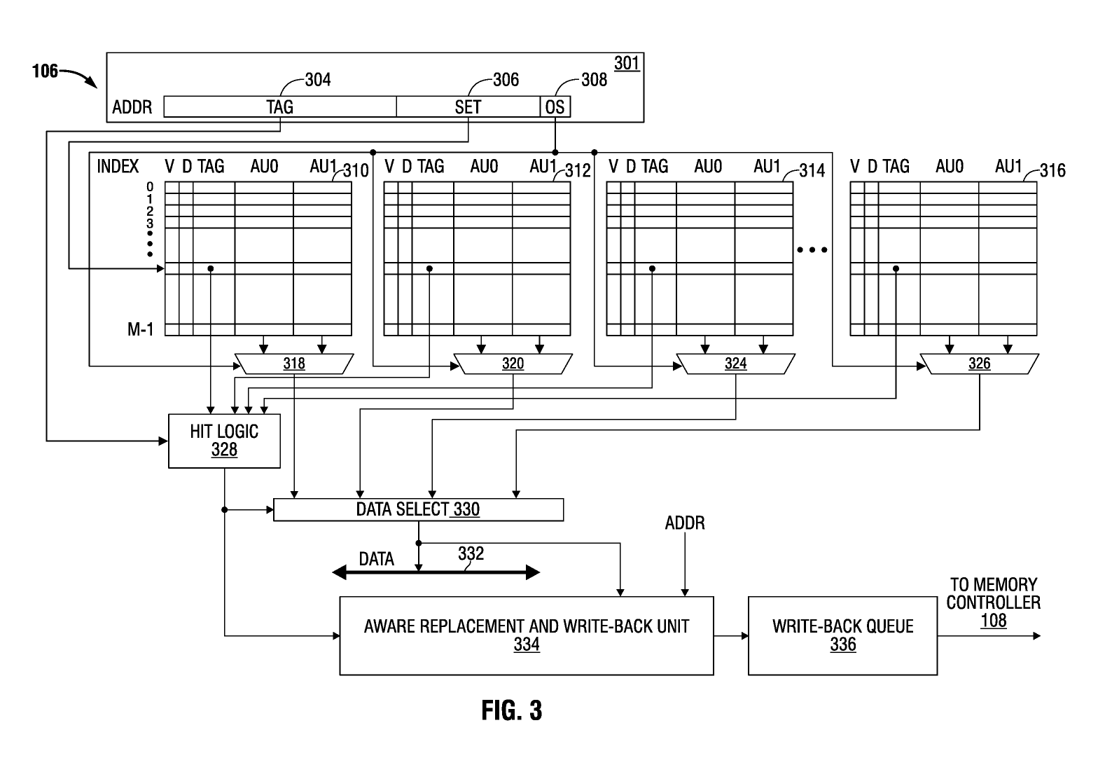

Referring to FIGS. 1 and 3, in at least one embodiment, last-level cache 106 includes a write-back cache implementing an aware cache replacement policy. Last-level cache 106 is an N-way, set-associative, write-back cache including ways 310, 312, 314, and 316. Each memory access by a thread that does not hit the private cache hierarchy (e.g., L1 and L2 caches) of the corresponding core 107, accesses last-level cache 106 using a physical address. For example, a portion of the memory address excluding the right-most bits (e.g., log₂(row buffer size) bits) are used as a tag to access last-level cache 106.

Each block in main memory 110 may be written to any of N different locations in last-level cache 106. Those N different locations form a set of N cache blocks (or cache elements), one in each way of last-level cache 106. To determine whether contents of a particular memory element actually resides in last-level cache 106, cache controller 301 searches all elements of the set using tag field 304 of the physical address. The bits of a memory address of a memory request may be partitioned into three portions: tag field 304, set field 306 (or index field 306), and offset field 308. Set field 306 identifies which row (or set of cache lines) of last-level cache 106 is used for the corresponding memory address. Each memory address may only be stored in a particular row of the cache. Tag field 304 identifies the address of the actual data fetched from main memory 110 and typically contains the most significant bits of the address. Offset field 308 indicates which block of the memory location is being accessed and makes the appropriate addressable unit (e.g., AU0 or AU1) available to be selected by data select 330 using select circuits 318, 320, 324, and 326. Cache controller 301 accesses a corresponding set including one element in each of way 310, way 312, way 314, and way 316 of last-level cache 106. Each cache block of set m has an identifying tag stored in a corresponding tag location.

Hit logic 328 compares tag bits of the memory address of a memory request to tag bits associated with the stored contents of a corresponding set of the cache to determine whether the set includes contents of the target memory location or the contents of another, irrelevant memory location that has the same set field 306 as the target memory location of the memory access. Hit logic 328 provides an indicator of that comparison (i.e., indicating a hit or a miss) to aware replacement and write-back unit 334. An associative search across the set for a match to tag 304 results in either a hit or a miss. If the associative search results in a hit and the memory access is a read, data select circuit 330 provides a corresponding addressable unit (e.g., AU0 or AU1) of the cache block to data bus 332 and aware replacement and write-back unit 334 updates temporal information associated with the N cache blocks including an indicator of a least-recently-used cache block of the N cache blocks of the set. If the associative search results in a hit and the memory access is a write, cache controller 301 writes data to the corresponding cache block and aware replacement and write-back unit 334 updates the temporal information associated with N cache blocks.

If the associative search results in a miss and the corresponding set has an available entry (e.g., an entry having a control bit, ‘V’ indicating that a block of the set is invalid), then last-level cache 106 reads the data from main memory, enters it in the available cache block and provides the appropriate addressable unit on data bus 332 for a read, and writes the data and the tag associated with the memory access into an available entry of the set and sets the corresponding control bit to indicate that the block contains valid data. In at least some embodiments of a memory system, prior to writing the data and into the available cache block, a write miss requires a read of the corresponding main memory location to ensure that all addressable units of a cache block contain current information. Aware replacement and write-back unit 334 updates the temporal information associated with the set.

If the associative search results in a miss and the control bits indicate that the corresponding set has no available entries, aware replacement and write-back unit 334 selects a cache block of the set for eviction and replacement. If control bits indicate that the contents of the selected cache block are dirty, (i.e., changed from the contents of the corresponding location in main memory 110), aware replacement and write-back unit 334 enters a write request for the contents of the selected cache block into write-back queue 336 that writes-back to main memory 110 the contents of the selected cache block. If the memory request is a read, cache controller 301 and aware replacement and write-back unit 334 also generates a read request that retrieves the requested data from main memory, enters the retrieved data in the selected cache block, enters the tag portion of the address into the corresponding tag location, and sets the associated control bit(s) to indicate clean, valid data, and updates temporal information accordingly. If the memory request is a write, cache controller 301 and aware replacement and write-back unit 334 enter data for the write into the selected cache block, enter the tag portion of the address into the corresponding tag location, set the associated control bits to indicate dirty, valid data, and update temporal information for the set. In at least some embodiments of a memory system, prior to writing the data into the selected cache block, a write miss requires a read of the corresponding main memory location to ensure that all addressable units of a cache block contain current information.

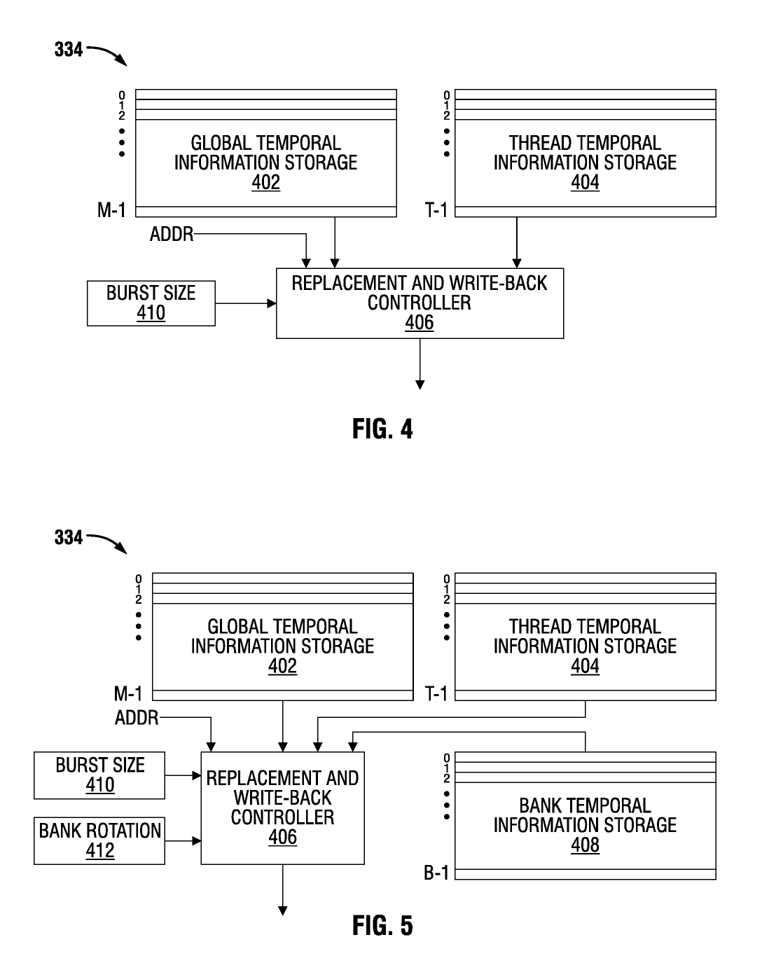

Referring to FIG. 4, in at least one embodiment, aware replacement and write-back unit 334 includes replacement and write-back controller 406 and temporal information stored in global temporal information storage 402 and thread temporal information storage 404. Global temporal information storage 402 stores bits indicating temporal relationships for each block of a corresponding set of the cache. The bits for a particular set indicate the age of each of the cache blocks relative to each other that may be used to identify a least-recently-used cache block. Each time a cache block of a particular set is accessed, replacement and write-back controller 406 updates the relative age of every cache block in the set. Accordingly, replacement and write-back controller 406 updates those bits in global temporal information storage 402 in response to each access of a cache block of the particular set to reflect the last update of each cache block in the set relative to each other. For example, global temporal information storage 402 may include a set of bits for each cache block of a set that indicate whether the cache block was more recently used or less-recently used than each other cache block of the set to which it belongs. In another embodiment, global temporal information storage 402 includes one set of temporal bits for each of the M sets of the cache. The set of temporal bits encodes an order of the recent usage of the cache blocks of the set. In an exemplary 4-way set associative cache, six bits may be used to encode the temporal relationship of each combination of two cache blocks, without repetition. In embodiments of a cache implementing a different number of ways may be used, a different number of bits are used to represent the appropriate temporal relationships between cache blocks of a set of the cache.

In addition to global temporal information storage 402, aware replacement and write-back unit 334 includes thread temporal information storage 404, which includes one set of temporal bits for each of the T threads executing on cores 107 of system 100 of FIG. 1. In at least one embodiment T is equal to the number of cores 107 included in system 100, i.e., one thread per core. In other embodiments, T is greater than the number of cores 107 included in system 100 and may dynamically vary during operation of system 100. Referring back to FIG. 4, aware replacement and write-back unit 334 uses the temporal information included in thread temporal information storage 404, global temporal information storage 402, and control information (e.g., contents of burst size register 410), to select one or more cache blocks for eviction in response to a cache miss.

Referring to FIG. 5, in at least one embodiment, aware replacement and write-back unit 334 includes memory structure-aware temporal information bits in additional storage structures. For example, bank temporal information storage 408 includes bits indicating temporal relationships between each of the cache blocks by each of the B banks of main memory. In an exemplary memory architecture, sixteen memory banks are used. Bank temporal information storage 408 includes sixteen sets of temporal bits. Each set of temporal bits indicates the temporal relationship of all cache blocks having an address corresponding to the bank. Aware replacement and write-back unit 334 uses the temporal information included in thread temporal information storage 404, bank temporal information storage 408, global temporal information storage 402, and control information (e.g., in burst size register 410 and bank rotation register 412) to select one or more cache blocks for eviction, as further described below. Bank rotation register may include a timer that indicates whether the associated memory bank is eligible for access (e.g., whether the memory bank has not been accessed within a predetermined number of previous clock cycles). Note that other registers may be included to indicate a number of threads executing on the processor(s), number of in-page bursts before switching memory pages, memory structure or other control information that may be used to select cache blocks for eviction. Global temporal information storage 402, thread temporal information storage 404, bank temporal information storage 408, burst size register 410 and bank rotation register 412 may be structures configured by a Basic Input/Output System (BIOS) or other suitable technique upon system startup or reset using information indicating the structure of main memory received from Read-Only Memory (ROM) and/or received from a user interface and stored in non-volatile memory, or combination thereof.

Referring to FIGS. 3, 4, and 6, in at least one embodiment, last-level cache 106 receives a memory request including an indication of the thread issuing the memory access (502) and compares a tag portion of the target memory address to the tags stored in a corresponding set of last-level cache 106. Hit logic determines whether the memory address tag matches a stored tag of a valid cache block in the set to result in a cache hit (504). In response to the cache hit, aware replacement and write-back unit 334 updates temporal information stored in the replacement and write-back unit (e.g., global temporal information storage 402 and thread temporal information storage 404) (516). In response to the access being a read, last-level cache 106 services the memory request by providing the contents of the cache block having the tag matching the tag of the memory address to data bus 332, which provides the data to a core that issued the memory request (518). In response to the access being a write, last-level cache 106 writes the data to the cache block having the tag matching the tag of the associated memory address sets a dirty bit if not already set (518).

If an invalid (i.e., available) cache block is in the set, in response to a cache miss, cache controller 301 updates temporal information and control information (516) and services the memory request using the available cache block and (518). If there are no invalid (i.e., available) cache blocks in the set, in response to the cache miss (504), aware replacement and write-back unit 334 determines a cache block that is least-recently-used by the thread that issued the memory request based on a corresponding entry in thread temporal information storage 404 and evicts the contents of that cache block (506). If that cache block is dirty, aware replacement and write-back unit 334 generates a write-back to main memory and generates a burst of writes to the same row of main memory by selecting another cache block for eviction associated with the same thread and the same row of main memory. Those cache blocks may be from the same set or different sets of the cache. If no cache blocks from that thread are associated with the same row of main memory, cache blocks associated with other threads are searched for tags matching that row of memory (508). Aware replacement and write-back unit 334 may increment a counter and continues to select additional dirty cache blocks for eviction by placing corresponding memory requests into write-back queue 336 until the write-back queue 336 includes a burst of write-back memory requests including a target number of consecutive write-back memory requests (510). Memory controller 108 receives the stream of memory requests and writes the evicted cache blocks to corresponding locations in main memory. Meanwhile, cache controller 301 services the memory requests and replaces the contents of at least one of the evicted cache block with data associated with one or more memory requests resulting in the cache miss and sets or resets the control bit(s) indicating dirty and/or valid data, accordingly (514).

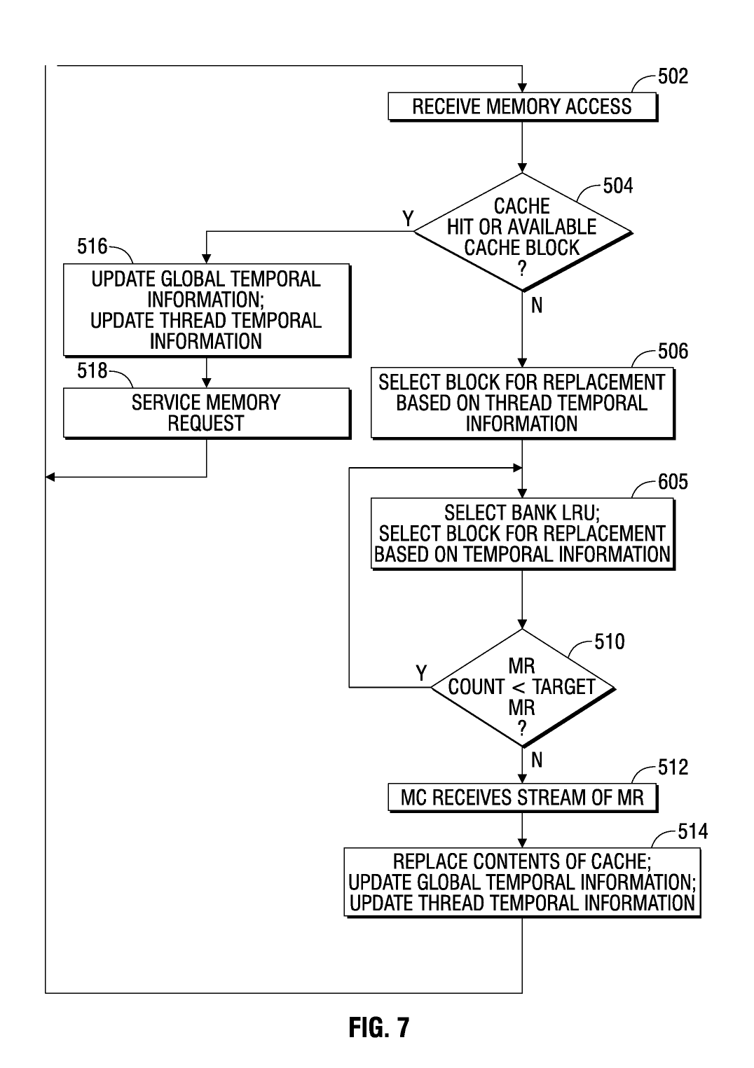

Referring to FIGS. 3, 5, and 7, in other embodiments, additional temporal information is used to select one or more cache blocks for eviction and write-back to main memory. For example, last-level cache 106 receives a memory request including an indication of the thread issuing the memory access (502) and compares tag portion of the memory address to the tags stored in a corresponding set of last-level cache 106. Hit logic determines whether the tag portion of the memory address matches a stored tag of a valid cache block of the set, i.e., whether the memory address results in a cache hit (504). In response to the cache hit, aware replacement and write-back unit 334 updates temporal information stored in the replacement and write-back unit (e.g., global temporal information storage 402, thread temporal information storage 404, and bank temporal information 408) (516). In response to the access being a read, last-level cache 106 services the memory request and provides the contents of the cache block having the tag matching the tag of the memory address to data bus 332, which provides the data to a core that issued the memory request (518). In response to the access being a write, last-level cache 106 writes the data to the cache block having the tag matching the tag of the memory address and sets a dirty bit, if not already set (518).

If an invalid (i.e., available) cache block is in the set, in response to a cache miss, cache controller 301 updates temporal information and control information (516) and services the memory request using the available cache block (518). If there are no invalid (i.e., available) cache blocks in the set, in response to the cache miss (504), aware replacement and write-back unit 334 determines a least-recently-used cache block that is least-recently-used by the thread that issued the memory request based on a corresponding entry in thread temporal information storage 404 and evicts the contents of that cache block (506). Aware replacement and write-back unit 334 selects a bank, e.g., a least-recently-used memory bank or bank that was not used in a last memory access or a bank that has an associated timer that indicates it has not been accessed in a predetermined number of clock cycles (605). In addition, aware replacement and write-back unit 334 may generate a burst of writes to the same bank and same row of main memory by selecting another dirty cache block for eviction associated with the same memory bank. Aware replacement and write-back unit 334 may increment a counter and continues to select additional dirty cache blocks for eviction by placing corresponding memory requests into write-back queue 336 until the write-back queue 336 includes a burst write-back memory request including a target number of consecutive write-back memory requests (510). Memory controller 108 receives the stream of memory requests and writes the evicted cache blocks to corresponding locations in main memory. Meanwhile, cache controller 301 services the memory request and replaces the contents of at least one of the evicted cache blocks with data associated with one or more memory requests resulting in the cache miss (514) and sets or resets control bit(s) indicating the data is dirty and/or valid accordingly.

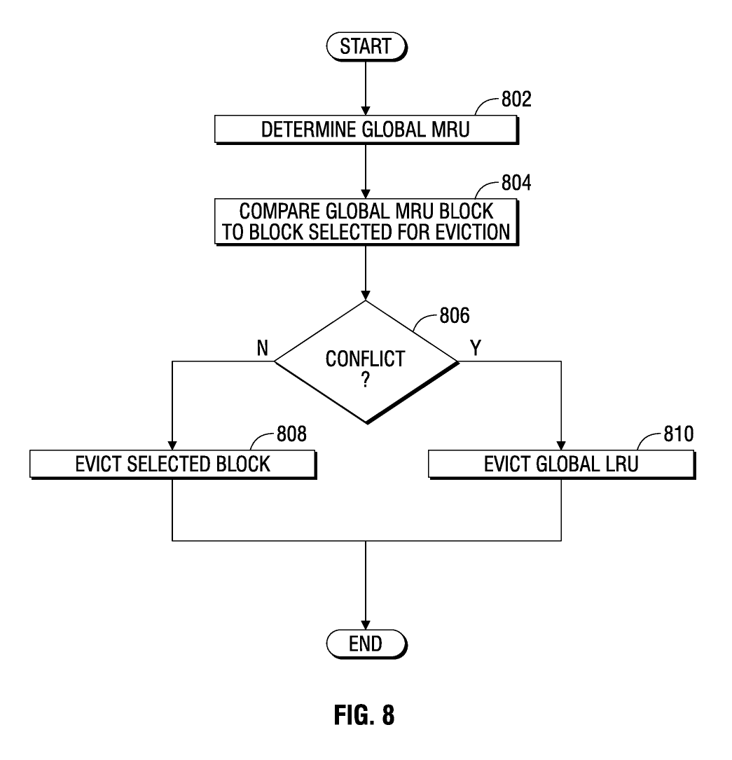

In at least one embodiment, while selecting a cache block for replacement, aware replacement and write-back unit 334 detects any conflict between the cache block selected for eviction and a global least-recently-used replacement policy. For example, referring to FIGS. 4, 5, and 8, aware replacement and write-back unit 334 determines a global most-recently-used cache block of a set using contents of global temporal information storage 402 (802). Aware replacement and write-back unit 334 compares that global most-recently-used cache block to a cache block selected for eviction by the aware replacement policy (e.g., according to one or more of thread temporal information, bank temporal information, or other information). If the global most-recently-used cache block is the same as the block selected for eviction by the aware replacement policy, then aware replacement and write-back unit 334 recognizes the conflict (806) and does not evict that selected block. Instead, aware replacement and write-back unit 334 evicts the global least-recently-used block and inserts a corresponding memory request into write-back queue 336, when dirty (810). In at least one embodiment, aware replacement and write-back unit 334 compares the cache block selected for eviction by the aware replacement policy to other cache blocks having global temporal information within an adjustable threshold of deviation from the most-recently-used. If the cache block selected for eviction by aware replacement and write-back unit 334 conflicts with the other cache blocks having global temporal information within an adjustable threshold of deviation from the most-recently-used (806), then aware replacement and write-back unit 334 recognizes the conflict and does not evict that selected block. Instead, aware replacement and write-back unit 334 evicts the global least-recently-used block and inserts a corresponding memory request into write-back queue 336, when dirty (810).

If the global most-recently-used cache block is different from the block selected for eviction by the aware replacement policy (806), then no conflict occurs and aware replacement and write-back unit 334 evicts the cache block selected by the aware cache replacement policy and inserts a corresponding memory request into write-back queue 336 when dirty (808). Although embodiments of the aware cache replacement policy include the aware cache replacement policy as the default replacement policy with conflict checking with the global least-recently-used policy, in other embodiments, rather than the aware policy being the default selection policy and the global least-recently-used policy being checked for conflicts, the global least-recently-used policy is the default policy and the selection may be replaced with a cache block selected for eviction by an aware policy if no conflict exists.

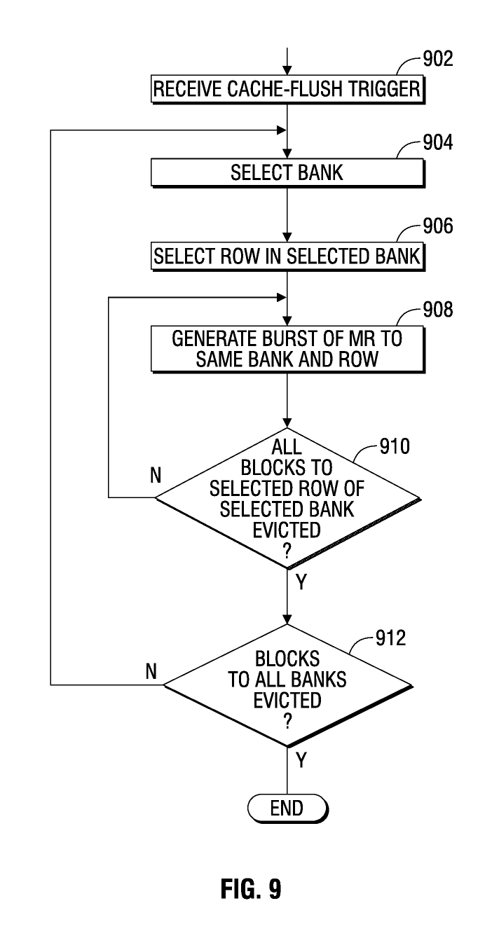

In at least one embodiment, aware replacement and write-back unit 334 applies memory structure information to decrease the memory latency of a cache flush operation. Referring to FIGS. 3 and 9, aware replacement and write-back unit 334 receives a cache-flush trigger from a processor (902). In response to receiving the cache flush trigger, aware replacement and write-back unit 334 selects a memory bank (904). Aware replacement and write-back unit 334 then selects a row of the bank, which may be an initial row or a next row of the selected bank (906). Aware replacement and write-back unit 334 inserts write-back requests into write-back queue 336 for any dirty and valid cache blocks having tags to the selected bank and row residing in the cache, thereby generating a burst of cache block writes to the same memory bank (908). If all of the cache blocks of the selected row of the selected bank have not been evicted (912) then cache controller 301 includes any additional dirty and valid cache blocks in the burst of blocks to the memory bank (908). If all of the cache blocks of the selected row of the selected bank have been evicted (910) but all of the cache blocks of all of the banks have not yet been evicted (912), then cache controller 301 selects a next bank (904) and selects a row in the next bank and includes any additional cache blocks in the selected row and selected bank to main memory. Aware replacement and write-back unit 334 continues to rotate the memory bank until all of the cache blocks of all of the rows of all of the banks have been evicted (912). By selecting cache blocks according to the aware cache replacement policy, the stream of cache block write-back requests in the write-back queue may be in a sequence that reduces the latency of a cache flush as compared to techniques that evict cache blocks in a sequence based on the cache structure alone.

While circuits and physical structures have been generally presumed in describing embodiments of the invention, it is well recognized that in modern semiconductor design and fabrication, physical structures and circuits may be embodied in computer-readable descriptive form suitable for use in subsequent design, simulation, test or fabrication stages. Structures and functionality presented as discrete components in the exemplary configurations may be implemented as a combined structure or component. Various embodiments of the invention are contemplated to include circuits, systems of circuits, related methods, and tangible computer-readable medium having encodings thereon (e.g., VHSIC Hardware Description Language (VHDL), Verilog, GDSII data, Electronic Design Interchange Format (EDIF), and/or Gerber file) of such circuits, systems, and methods, all as described herein, and as defined in the appended claims. In addition, the computer-readable media may store instructions as well as data that can be used to implement the invention. The instructions/data may be related to hardware, software, firmware or combinations thereof.

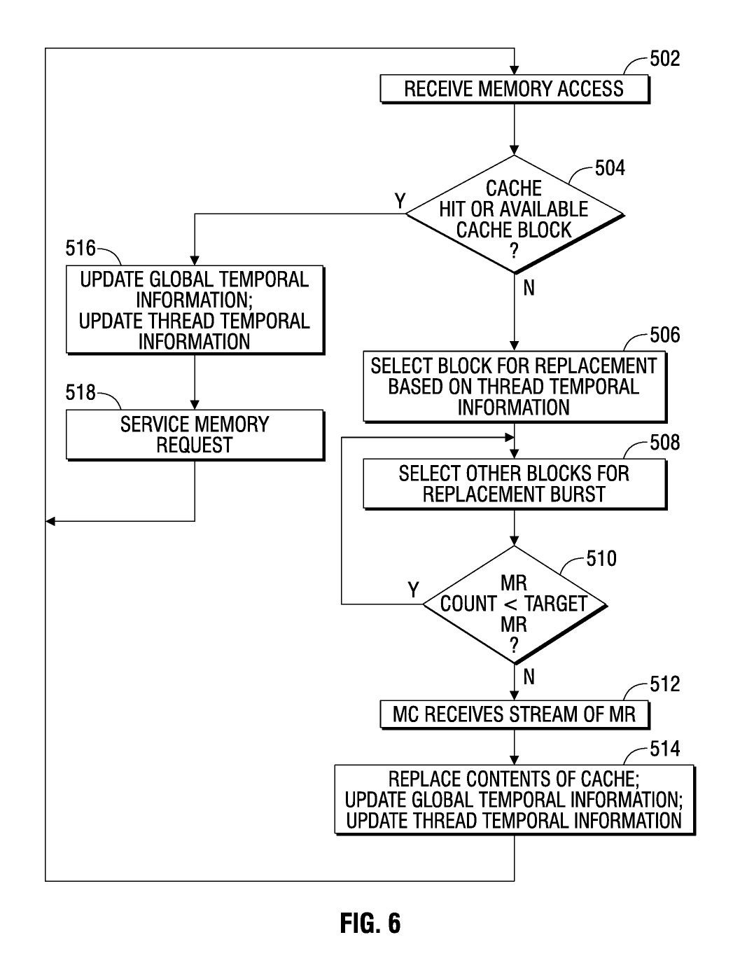

The description of the invention set forth herein is illustrative, and is not intended to limit the scope of the invention as set forth in the following claims. For example, while the invention has been described in an embodiment in which particular memory structure, one of skill in the art will appreciate that the teachings herein can be utilized with other memory structures using other numbers of cache levels or other main memory organizations. In addition, note that the orders of information and control flows of FIGS. 6-9 are exemplary only and other sequences that preserve data dependencies of FIGS. 6-9 may vary in other embodiments of last-level cache 106. Variations and modifications of the embodiments disclosed herein, may be made based on the description set forth herein, without departing from the scope of the invention as set forth in the following claims.

What is claimed is:

1. A method comprising:
concurrently executing a plurality of threads on at least one processor; and
in response to a first memory request issued by a first thread of the plurality of threads resulting in a cache miss of a write-back cache memory, selecting a cache block of the write-back cache for eviction, the cache block being selected using thread temporal information corresponding to cache block usage by each thread executing on the at least one processor and global temporal information for cache block usage for all threads of the plurality of threads.

2. The method, as recited in claim 1, further comprising:
updating the thread temporal information and the global temporal information in response to the first memory request.

3. The method, as recited in claim 1, further comprising:
generating a write-back burst including write requests for each dirty cache block of the cache block and the additional cache blocks of the write-back cache for eviction, the burst of memory requests having addresses in a common portion of memory.

4. The method, as recited in claim 3, further comprising:
selecting the additional cache blocks of the write-back cache for eviction based on a predetermined number of memory requests for a write-back burst.

5. The method, as recited in claim 3, wherein generating the write-back burst comprises:
selecting a plurality of additional cache blocks of the write-back cache for eviction targeting the common portion of memory of the cache block.

6. The method, as recited in claim 3, wherein the common portion of memory is a common memory bank.

7. The method, as recited in claim 3, wherein the common portion of memory is a common row of a common memory bank.

8. The method, as recited in claim 3, further comprising:
writing the write request to the write-back memory request queue in absence of a conflict with a global cache block temporal usage policy.

9. The method, as recited in claim 1, wherein the selecting includes determining that the cache block is not a most-recently-used cache block for a global cache block temporal usage policy.

10. An apparatus comprising:
at least one processor configured to concurrently execute a plurality of threads; and
a write-back cache comprising:
a global temporal information storage element configured to store temporal information for cache block usage by all threads of the plurality of threads;
a thread temporal information storage element configured to store temporal information for cache block usage by each thread of the plurality of threads; and
replacement and write-back controller configured to select a cache block of the write-back cache for eviction in response to a first memory request issued by a first thread of the plurality of threads resulting in a cache miss of the write-back cache, the cache block being selected using contents of the global temporal information storage element and contents of the thread temporal information storage element.

11. The apparatus, as recited in claim 10, wherein the write-back cache further comprises:
a write-back memory request queue configured to store write requests corresponding to dirty cache blocks selected for eviction from the write-back cache; and
a memory controller configured to write to main memory, data of the write requests in the write-back memory request queue.

12. The apparatus, as recited in claim 11, wherein the replacement and write-back controller is further configured to write the write request to the write-back memory request queue in absence of a conflict with a global cache block temporal usage policy.

13. The apparatus, as recited in claim 11, wherein the replacement and write-back controller is further configured to write the write request to the write-back memory request queue in response to the cache block not being a most-recently-used cache block for the global cache block temporal usage policy.

14. The apparatus, as recited in claim 10, wherein the write-back cache further comprises:
a bank temporal information storage element configured to store temporal information for each bank of main memory.

15. The apparatus, as recited in claim 10, wherein the bank least-recently-used replacement control storage element is further configured to store least-recently-used information for rows of each bank of the main memory.

16. The apparatus, as recited in claim 10, wherein the write-back cache further comprises:
a burst size storage element configured to store a number corresponding to a predetermined number of memory requests in a write-back burst,
wherein the replacement and write-back controller is configured to select a plurality of additional cache blocks of the write-back cache for eviction based on contents of the burst-size storage element.

17. The apparatus, as recited in claim 10, further comprising:
a memory controller configured to receive write request bursts from the write request queue and handle the write request bursts in write-back queue order, individual write request bursts being uninterrupted.

18. A method for reducing memory access time of a cache flush comprising:
in response to receiving a cache flush trigger, generating a write-back memory request stream to a main memory, the write-back memory request stream including a write request corresponding to each valid and dirty cache block, the write memory request stream including bursts of write requests, each write request in each burst having a destination location in a first portion of the main memory.

19. The method, as recited in claim 18, wherein the first portion is a first memory bank.

20. The method, as recited in claim 18, wherein the first portion is a first row of a first memory bank.
